(19) United States
(12) Patent Application Publication
(10) Pub. No.: US 2006/0054405 A1
(43) Pub. Date: Mar. 16, 2006

(54) System and method of supplying hydraulic fluid

(76) Inventors: Dennis R. Custer, West Granby, CT (US); James N. Usko, North Granby, CT (US)

Correspondence Address: COLLIER SHANNON SCOTT, PLLC, 3050 K STREET, NW, SUITE 400, WASHINGTON, DC, 20007, US

(21) Appl. No.: 11/131,312

(22) Filed: May 18, 2005

Related U.S. Application Data
(60) Provisional application No. 60/571,871, filed on May 18, 2004.

(51) Int. Cl. F16N 29/00

(52) U.S. Cl. 184/6

(57) ABSTRACT

Systems and methods of supplying hydraulic fluid are disclosed. In one embodiment of the present invention, the system comprises a rocker arm shaft having an axis and an outer surface; a rocker arm pivotally mounted on the rocker arm shaft; a bore formed in the rocker arm shaft parallel to the rocker arm shaft axis, the bore having an inner surface; a fluid supply source in communication with the bore; and a divider assembly operatively connected to the bore, wherein at least one hydraulic passage is formed between the rocker arm shaft and the divider assembly.

### CROSS-REFERENCE TO RELATED APPLICATION

This application relates to and claims priority on U.S. Provisional Application No. 60/571,871, filed May 18, 2004 and entitled “System and Method for Supplying Hydraulic Fluid,” a copy of which is incorporated herein by reference in its entirety.

### FIELD OF THE INVENTION

The present invention generally relates to a rocker shaft for use in internal combustion engines. Specifically, the present invention relates to systems and methods for providing multiple hydraulic fluid circuits in a rocker shaft.

### BACKGROUND OF THE INVENTION

Internal combustion engines typically use either a mechanical, electrical, or hydro-mechanical valve actuation system to actuate an engine valve and produce an engine valve event. These valve actuation systems may include one or more rocker arms that rotate about a rocker shaft in response to valve actuation motion provided by a valve train element, such as a camshaft. These systems may also include various components in the engine valve train that perform additional functions. These components may include, without limitation, engine brakes, lash adjusters, exhaust gas recirculation (EGR) systems, rocker coupling devices, clip devices, and/or valve catch devices. The operation of many of these components may rely upon the selective supply of hydraulic fluid.

Rocker shafts are often used not only to provide a pivot for the rocker arms, but also as a means for supplying the hydraulic fluid required to lubricate the rocker arms and to operate the various hydraulic components of the valve actuation system. Using the rocker shaft to supply hydraulic fluid to the system, however, can lead to manufacturing and design issues.

In order to provide hydraulic fluid to the various components, multiple passages are typically drilled through the length of the rocker shaft. Because of the relatively small cross-sectional area of the rocker shaft, accuracy in the drilling process may be required to prevent one passage from intersecting another. In addition, each passage that is drilled may reduce the structural integrity of the rocker shaft due to its relatively small cross-sectional area. As the available space in which to drill the necessary multiple passages is minimal, the passages are often in close proximity to each other. This may create substantially thin walls between each supply passage. Because of the sensitive nature of thin walls when exposed to a heat-treating process, greater quality control may be required in order to prevent parts from cracking.

### SUMMARY OF THE INVENTION

Responsive to the foregoing challenges, Applicant has developed innovative systems and methods of supplying hydraulic fluid. In one embodiment, the system comprises a rocker arm shaft having an axis and an outer surface; a rocker arm pivotally mounted on the rocker arm shaft; a bore formed in the rocker arm shaft parallel to the rocker arm shaft axis, the bore having an inner surface; a fluid supply source in communication with the bore; and a divider assembly operatively connected to the bore, wherein at least one hydraulic passage is formed between the rocker arm shaft and the divider assembly.

Applicant has further developed a system comprising: a rocker shaft having a center axis; a rocker arm pivotally mounted on the rocker arm shaft; a bore formed in the rocker shaft parallel to the center axis of the rocker shaft; a fluid supply source in communication with the bore; and a divider assembly disposed in the bore, wherein a plurality of hydraulic passages are formed between the rocker arm shaft and the divider assembly.

Applicant has further developed a system for supplying hydraulic fluid to one or more components of a valve actuation system in an internal combustion engine, comprising: a rocker arm shaft; a rocker arm pivotally disposed on the rocker shaft; a main fluid supply bore formed in the rocker shaft disposed parallel to the axis of the rocker shaft; at least one groove formed in an outer surface of the rocker shaft, the groove being disposed parallel to the axis of the rocker shaft; at least one supply passage formed in the rocker shaft perpendicular to the axis of the rocker shaft, the supply passage operatively connecting the at least one groove to the main fluid supply bore; and a sleeve disposed around the outer surface of the rocker arm shaft, wherein a hydraulic passage is formed between each of the grooves and the sleeve.

It is to be understood that both the foregoing general description and the following detailed description are exemplary and explanatory only, and are not restrictive of the invention as claimed. The accompanying drawings, which are incorporated herein by reference, and which constitute a part of specification, illustrate certain embodiments of the invention and, together with the detailed description, serve to explain the principles of the present invention.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1A is a schematic diagram of a hydraulic fluid supply system in accordance with an embodiment of the present invention.

FIG. 1B is a schematic diagram of a hydraulic fluid supply system in accordance with an alternative embodiment of the present invention.

FIG. 2 is a cross-sectional view of a rocker shaft in accordance with an embodiment of the present invention.

FIG. 3 is a cross-sectional view of a rocker shaft and divider assembly in accordance with an embodiment of the present invention.

FIG. 4A is a perspective view of a divider in accordance with a first embodiment of the present invention.

FIG. 4B is a cross sectional view of the rocker shaft and divider in accordance with the first embodiment of the present invention.

FIG. 4C is a perspective view of the divider in accordance with a second embodiment of the present invention.

FIG. 4D is a cross sectional view of the rocker shaft and divider in accordance with the second embodiment of the present invention.

FIG. 4E is a perspective view of the divider in accordance with a third embodiment of the present invention.

FIG. 4F is a cross sectional view of the rocker shaft and divider in accordance with the third embodiment of the present invention.

FIG. 4G is a perspective view of the divider in accordance with a fourth embodiment of the present invention.

FIG. 4H is a cross sectional view of the rocker shaft and divider in accordance with the fourth embodiment of the present invention.

FIG. 5 is a cross sectional view of a rocker shaft in accordance with an embodiment of the present invention.

FIG. 6 is a perspective view of a rocker shaft in accordance with an embodiment of the present invention.

FIG. 7 is a schematic diagram of a hydraulic fluid supply system used in conjunction with an engine brake system in accordance with an embodiment of the present invention.

### DETAILED DESCRIPTION OF EMBODIMENTS OF THE INVENTION

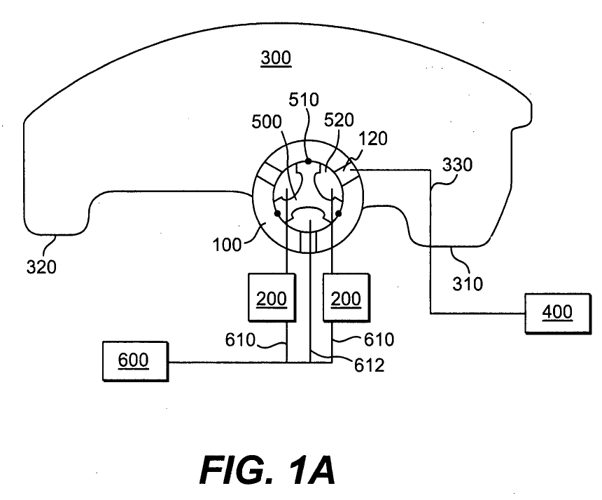

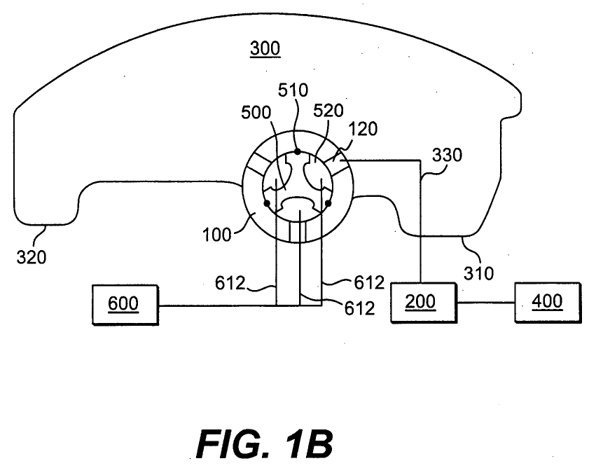

Reference will now be made in detail to a first embodiment of the present invention, an example of which is illustrated in the accompanying drawings. With reference to FIG. 1A, an hydraulic fluid supply system is shown. The supply system may include a rocker shaft 100 on which one or more rocker arms 300 are disposed. A rocker shaft divider assembly 500 is disposed in the rocker shaft 100 such that hydraulic fluid may be supplied from a fluid supply source 600 to one or more valve actuation system components 400 through one or more hydraulic passages 520 formed between the divider assembly 500 and the rocker shaft 100.

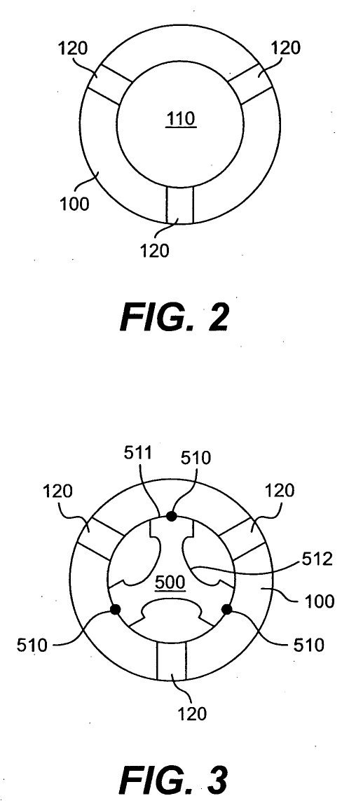

With reference to FIGS. 1A and 2, the rocker shaft 100 may include a main supply bore 110 in communication with the fluid supply source 600. The bore 110 may be disposed in the center of the rocker shaft 100, and may extend through a portion of the shaft 100. Alternatively, in one embodiment of the present invention, the bore 110 may extend through the entire length of the shaft 100. One or more supply passages 120 may be disposed in the rocker shaft 100 perpendicular to the axis of the rocker shaft 100. The supply passages 120 may be located between the bore 110 and the valve actuation system components 400. In this manner, hydraulic fluid may be supplied through the rocker shaft 100 for multiple purposes.

The valve actuation system components 400 may include, without limitation, engine brakes, lash adjusters, exhaust gas recirculation (EGR) systems, rocker coupling devices, clip devices, and/or valve catch devices. Other components that require hydraulic fluid to operate are considered well with in the scope and spirit of the present invention. In addition, hydraulic fluid may be supplied through the rocker shaft 100 to provide lubrication to the rocker arm 300.

With continued reference to FIG. 1A, one or more rocker arms 300 may be pivotally mounted on the rocker shaft 100. The rocker arm 300 may comprise an exhaust rocker arm, a dedicated rocker arm, an injector rocker arm, and/or an intake rocker arm. The rocker arm 300 may be pivoted about the rocker shaft 100 as a result of motion imparted to it by a camshaft (not shown) or another suitable motion imparting device. The rocker arm 300 may receive a motion at a first end 310 and may transmit the motion received to a second end 320. The rocker arm 300 may transmit the motion to an engine valve (not shown) by contacting it directly, through a valve actuator, through a pin, or through a valve bridge. The engine valves may include an exhaust valve, an intake valve, and/or a dedicated valve.

One or more hydraulic circuits 330 may operatively connect the fluid supply passages 120 to the valve actuation system components 400. In one embodiment of the present invention, the hydraulic circuits 330 are disposed in the rocker arm 300. It is contemplated that all or a portion of the hydraulic circuits 330 may be disposed elsewhere, such as, for example, the engine overhead, a rocker cap, and/or an engine brake housing.

With reference to FIGS. 1A and 1B, one or more control valves 200 may be in communication with the supply source 600 for selectively controlling the flow of hydraulic fluid from the supply source 600 to the system components 400. In one embodiment, one or more control valves 200 may be disposed in hydraulic passages 610 between the supply source 600 and the rocker shaft 100. For example, as shown in FIG. 1A, one control valve 200 may be disposed in a first hydraulic passage 610 and a second control valve 200 may be disposed in a second hydraulic passage 610. A third hydraulic passage 612 may be provided without a control valve 200 such that hydraulic fluid may be constantly supplied to the rocker shaft 100 to provide lubrication to the rocker arm 300. It is appreciated that the number and location of control valves 200 provided may be adapted to provide the necessary supply of hydraulic fluid to the valve actuation system components 400. In an alternative embodiment, as shown in FIG. 1B, one or more control valves 200 may be disposed in the hydraulic circuit 330 between the supply passage 120 and the component 400.

The control valve 200 may be activated and/or deactivated to allow and/or prevent fluid from flowing through the hydraulic circuit 330 to the component 400. In one embodiment of the present invention, the control valve 200 comprises a solenoid valve. It is contemplated that other suitable devices may be used to control the flow of fluid through the hydraulic circuit 330, including, but not limited to, butterfly valves, globe valves, ball valves, proportional valves, diaphragm valves, and/or their equivalent. The control valve 200 may activate/deactivate in response to a signal received from a controller (not shown).

As shown in FIGS. 1A, 1B, and 3, a divider assembly 500 may be disposed within the main supply bore 110. The divider assembly 500 may include a divider 500 having one or more contact surfaces 511 for contacting the inner surface of the bore 110, and one or more non-contact surfaces 512. The non-contact surfaces 512 may have a concave surface such that hydraulic passages 520 may be established between the inner surface of the bore 110 and the non-contact surfaces 512.

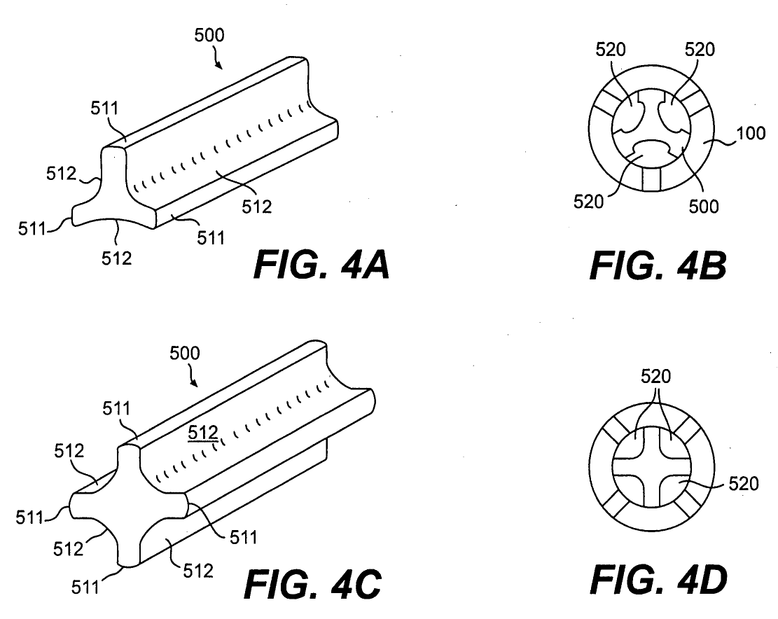

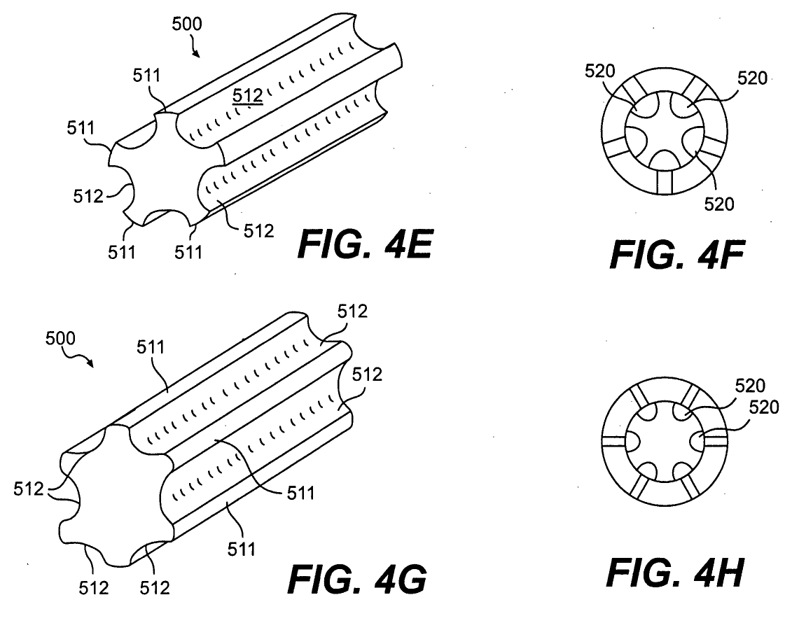

With reference to FIGS. 4a through 4h, the divider 500 may include any number of contact and non-contact surfaces 511, 512. As shown in FIGS. 4a and 4b, the divider 500 may comprise three contact surfaces 511 and three non-contact surfaces 512 such that three hydraulic passages 520 are formed. As shown in FIGS. 4c and 4d, in one embodiment of the present invention, the divider 500 may comprise four contact surfaces 511 and four non-contact surfaces 512 such that four hydraulic passages 520 are formed. As shown in FIGS. 4e and 4f, in one embodiment of the present invention, the divider 500 may comprise five contact surfaces 511 and five non-contact surfaces 512 such that five hydraulic passages 520 are formed. As shown in FIGS. 4g and 4h, in one embodiment of the present invention, the divider 500 may comprise six contact surfaces 511 and six non-contact surfaces 512 such that six hydraulic passages 520 are formed. It is contemplated that the divider 500 may be adapted to provide the number of hydraulic passages 520 necessary to supply hydraulic fluid to the necessary components 400.

In one embodiment of the present invention, the divider assembly 500 may further comprise one or more hydraulic seals 600 disposed between the contact surface 511 and the inner surface of the bore 110. The seal 600 may comprise any material that may substantially prevent leakage of fluid between the inner surface of the bore 110 and the contact surface 511 of the divider 500.

Operation of an embodiment of the present invention will now be described with reference to FIGS. 1A-4. Hydraulic fluid, such as engine oil, may be supplied from the fluid supply source 600 to each independent hydraulic passage 520 established between the inner surface of the bore 110 and the non-contact surfaces 512 of the divider 500. In the embodiments of the present invention in which one or more control valves 200 are disposed between the supply source 600 and the rocker shaft 100, the control valve 200 may be selectively activated to control fluid flow to the hydraulic passages 520. The hydraulic fluid may flow through each supply passage 120 to each hydraulic circuit 330, and to each component 400. In the embodiments of the present invention in which one or more control valves 200 is disposed between the rocker shaft 100 and the system components 400, the control valve 200 may be controlled at this point to selectively control fluid flow to each component 400. In this manner, the bore 110 in the rocker shaft 100 may be utilized to independently provide hydraulic fluid to various system components to achieve various functions.

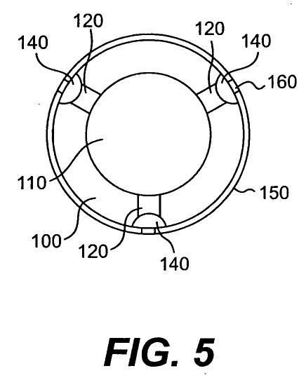

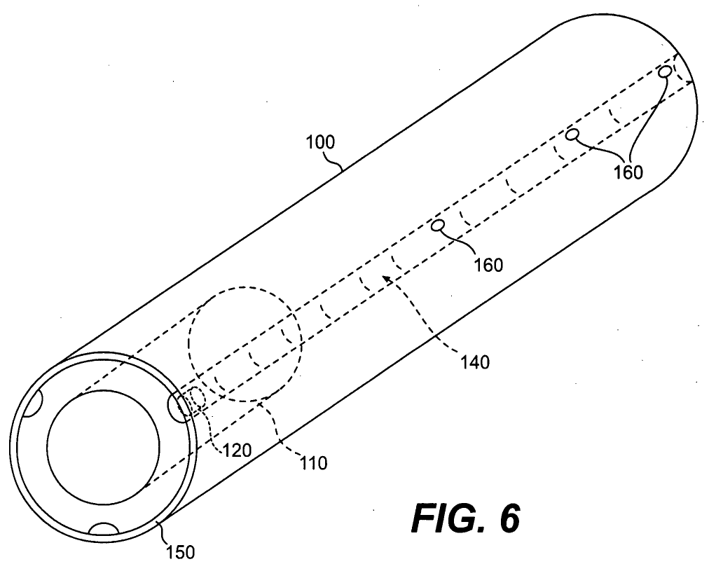

With reference to FIGS. 5 and 6, a second embodiment of the present invention will now be described. A rocker shaft 100 may have a bore 110 drilled or machined through its center, with the bore 110 disposed parallel to the center axis of the rocker shaft 100. The bore 110 may be provided in a portion of the rocker shaft 100, beginning at one end of the rocker shaft 100. The rocker shaft 100 may include one or more grooves 140 machined into the outside surface of the rocker shaft 100. One or more supply passages 120 may be disposed in the rocker shaft 100 perpendicular to the axis of the rocker shaft 100. The supply passages 120 may be located between the bore 110 and the grooves 140. A sleeve 150 may be disposed over the outside surface of the rocker shaft 100 such that the grooves 140 are substantially sealed. One or more holes 160 may be formed in the sleeve 150. In this manner, one or more hydraulic passages are formed between the sleeve 150 and the grooves 140, and the bore 110 in the rocker shaft 100 may be utilized to independently provide hydraulic fluid to various system components to achieve various functions.

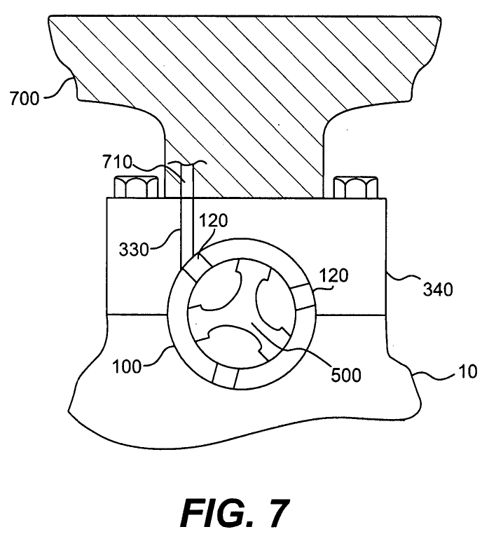

It will be apparent to those skilled in the art that various modifications and variations may be made in the construction, configuration, and/or operation of the present invention without departing from the scope or spirit of the invention. Embodiments of the present invention may be used in conjunction with a variety of valve actuation systems, including engine braking systems. With reference to FIG. 7, in which like reference numerals refer to like elements, a schematic diagram of a hydraulic fluid supply system according to an embodiment of the present invention is shown in conjunction with an engine brake housing 700, and a rocker cap 340 bolted on the engine head 10. Hydraulic fluid may be supplied through the supply passage 120, through the hydraulic circuit 330 formed, for example, in the rocker cap 340, and to a passage 710 formed in the engine brake housing 700. The passage 710 may then supply hydraulic fluid to a hydraulic component of the engine brake system. In this manner, hydraulic fluid may be supplied to a hydraulic component without drilling the passage in the engine head 10.

What is claimed is:

1. A system for supplying hydraulic fluid to one or more components of a valve actuation system in an internal combustion engine, said supply system comprising:
a rocker arm shaft having an axis and an outer surface;
a rocker arm pivotally mounted on said rocker arm shaft;
a bore formed in said rocker arm shaft parallel to the rocker arm shaft axis, said bore having an inner surface;
a fluid supply source in communication with said bore; and
a divider assembly operatively connected to said bore, wherein at least one hydraulic passage is formed between said rocker arm shaft and said divider assembly.

2. The system of claim 1, wherein said divider assembly comprises a divider disposed in said bore, said divider having a plurality of contact surfaces for contacting the inner surface of said bore.

3. The system of claim 2, further comprising sealing means provided between each contact surface and the inner surface of said bore.

4. The system of claim 2, said divider having three contact surfaces.

5. The system of claim 2, said divider having four contact surfaces.

6. The system of claim 2, said divider having five contact surfaces.

7. The system of claim 2, said divider having six contact surfaces.

8. The system of claim 2, further comprising a supply passage formed in said rocker arm shaft, said supply passage in communication with the hydraulic passage.

9. The system of claim 8, said supply passage disposed perpendicular to the rocker arm shaft axis.

10. The system of claim 1, wherein said divider assembly comprises:
a groove formed in the outer surface of said rocker arm shaft; and
a sleeve disposed around the outer surface of said rocker arm shaft, wherein a hydraulic passage is formed between said groove and said sleeve.

11. The system of claim 10, further comprising a supply passage formed in said rocker arm shaft, said supply passage in communication with the hydraulic passage.

12. The system of claim 2, further comprising a hydraulic circuit operatively connecting the valve actuation system component to the hydraulic passage.

13. A system for supplying hydraulic fluid to one or more components of a valve actuation system in an internal combustion engine, said supply system comprising:
a rocker arm shaft having a center axis;
a rocker arm pivotally mounted on said rocker arm shaft;
a bore formed in said rocker arm shaft parallel to the center axis of said rocker shaft;
a fluid supply source in communication with said bore; and
a divider assembly disposed in said bore, wherein a plurality of hydraulic passages are formed between said rocker arm shaft and said divider assembly.

14. The fluid supply system of claim 13, further comprising one or more supply passages formed in said rocker arm shaft disposed perpendicular to the center axis.

15. The fluid supply system of claim 14, wherein said divider assembly comprises:
a divider having a plurality of contact surfaces for contacting an inner surface of said bore; and
a plurality of hydraulic seals, one seal provided between each contact surface and the inner surface of said bore.

16. The fluid supply system of claim 15, wherein the number of contact surfaces is selected from the group consisting of: three, four, five, and six.

17. The fluid supply system of claim 13 further comprising a control valve disposed between said fluid supply source and said rocker arm shaft.

18. The fluid supply system of claim 13, further comprising a control valve disposed between said rocker arm shaft and the valve actuation system component.

19. A system for supplying hydraulic fluid to one or more components of a valve actuation system in an internal combustion engine, said supply system comprising:
a rocker arm shaft;
a rocker arm pivotally disposed on said rocker shaft;
a main fluid supply bore formed in said rocker shaft disposed parallel to the axis of the rocker shaft;
at least one groove formed in an outer surface of said rocker shaft, said groove being disposed parallel to the axis of said rocker shaft;
at least one supply passage formed in said rocker shaft perpendicular to the axis of said rocker shaft, said supply passage operatively connecting said at least one groove to said main fluid supply bore; and
a sleeve disposed around the outer surface of said rocker arm shaft, wherein a hydraulic passage is formed between each of said grooves and said sleeve.
